(19) United States
(12) Patent Application Publication
(10) Pub. No.: US 2024/0270436 A1
(43) Pub. Date: Aug. 15, 2024

(54) PAPER-BASED BAKEABLE TRAY WITH DIECUTS

(71) Applicant: Smart Packaging, LLC, Minnetonka, MN (US)

(72) Inventor: Jeffrey D. Pugh, Minnetonka, MN (US)

(21) Appl. No.: 18/623,896

(22) Filed: Apr. 1, 2024

Related U.S. Application Data
(63) Continuation of application No. PCT/US22/77399, filed on Sep. 30, 2022.
Application No. PCT/US22/77399 is a continuation-in-part of application No. 17/449,742, filed on Oct. 1, 2021.
(60) Provisional application No. 63/263,307, filed on Oct. 29, 2021.
(60) Provisional application No. 63/265,251, filed on Dec. 10, 2021.

(51) Int. Cl. B65D 1/34; B65D 81/34

(52) U.S. Cl. CPC B65D 1/34; B65D 81/343

(57) ABSTRACT

A paper-based bakeable tray having a bottom area, a peripheral sidewall disposed around said bottom area and extending a distance upwardly from said bottom area thereby defining a tray volume in which a food product is received. The bottom area includes a plurality of diecuts. The bottom area may be generally flat or may have raised contour surfaces or an embossed pattern, or a combination of any of the foregoing. The tray may include retaining tabs that may be folded upwardly to help retain the food product on the tray when inserting the tray with the food product into the oven.

### PRIORITY APPLICATIONS

This application claims priority to the PCT Application No.: PCT/US22/77399, filed Sep. 30, 2022 and claims priority to U.S. patent application Ser. No.: 17/449,742, filed Oct. 1, 2021 and U.S. Provisional Application No. 63/263,307, filed Oct. 29, 2021 and U.S. Provisional Application No.: 63/265,251, filed Dec. 10, 2021.

### BACKGROUND

Paper-based, oven-ready or bakeable trays are well known in the art for baking, heating, or reheating foods. Such paper-based bakeable trays are commonly used by “take-and-bake” pizza companies. Paper-based bakeable trays are also used by makers of frozen pizza, partial baked “par-bake” and raw pizza dough. These paper-based bakeable trays include barrier coatings such that they are impermeable to liquids and can withstand typical oven temperatures. While these trays may serve their intended purpose, it has been found that when foods are baked in these conventional trays, the food may not cook uniformly resulting in the food in the middle of the tray often being soft and doughy or not uniformly crisp. Accordingly there is a need for a paper-based bakeable tray that promotes uniform cooking and which can produce uniformly crisp crusts.

### DESCRIPTION OF THE DRAWINGS

FIG. 1 is a perspective view of one type of conventional paper-based bakeable tray with a flat bottom area and without a peripheral lip.

FIG. 2 is a perspective view of another type of conventional paper-based bakeable tray with a peripheral lip and with raised contour surfaces in the form of a pinwheel pattern on the bottom area of the tray.

FIG. 3 is a perspective view of yet another type of conventional paper-based bakeable with a peripheral lip and with raised contour surfaces in the form of an octagonal pattern on the bottom area of the tray.

FIG. 4A is a partial cross-sectional view of the flat bottomed paper-based bakeable tray as viewed along lines 4A-4A of FIG. 1.

FIG. 4B is a partial cross-sectional view of the paper-based bakeable tray as viewed along lines 4B-4B of FIG. 2.

FIG. 4C is a partial cross-sectional view of the paper-based bakeable tray as viewed along lines 4C-4C of FIG. 3.

FIG. 5 is a plan view of one embodiment of a paper-based bakeable tray similar to the conventional paper-based bakeable tray of FIG. 1, but incorporating an embossed pattern on the bottom area of the tray.

FIG. 5A is a partial cross-sectional view of the embossed paper-based bakeable tray of

FIG. 5 as viewed along lines A-A of FIG. 5 showing only upward projections in cross-section.

FIG. 5B is a partial cross-sectional view of the embossed paper-based bakeable tray of FIG. 5 as viewed along lines A-A of FIG. 5 showing only downward projections in cross-section.

FIG. 6 is a plan view of one embodiment of a paper-based bakeable tray similar to the conventional paper-based bakeable tray of FIG. 1, but incorporating an embossed pattern on the bottom area of the tray, with the embossed pattern comprising both upward projections and downward projections.

FIG. 6A is a partial cross-sectional view of the embossed paper-based bakeable tray of FIG. 6 as viewed along lines A-A of FIG. 6 showing the upward projections and downward projections in cross-section.

FIG. 7 is a plan view of one embodiment of a paper-based bakeable tray similar to conventional paper-based bakeable tray of FIG. 2 having raised contour surfaces in the form of a pinwheel, but incorporating an embossed pattern on the bottom area of the tray, with the embossed pattern comprising either upward projections or downward projections.

FIG. 8 is a plan view of one embodiment of a paper-based bakeable tray with raised contour surfaces in the form of a pinwheel as in FIG. 2 having raised contour surfaces in the form of a pinwheel, but with an embossing pattern comprising upward projections and downward projections on the bottom area of the tray.

FIG. 9 is a plan view of one embodiment of a paper-based bakeable tray similar to the conventional paper-based bakeable tray of FIG. 3 having raised contour surfaces in the form of an octagonal pattern, but incorporating an embossing pattern comprising upward projections on the bottom area of the tray.

FIG. 10 is a plan view of one embodiment of a paper-based bakeable tray similar to the conventional paper-based bakeable tray of FIG. 3 having raised contour surfaces in the form of an octagonal pattern, but with an embossing pattern comprising upward projections and downward projections on the bottom area of the tray.

FIG. 11 is a plan view of one embodiment of a die having a peripheral blade and interior blades to produce a circular tray blank with a plurality of half-moon diecuts.

FIG. 12 is a plan view of tray of FIG. 1 with half-moon diecuts in the bottom area of the tray cut using the die of FIG. 11.

FIG. 13 is a plan view of tray of FIG. 2 with half-moon diecuts in the bottom area of the tray cut using the die of FIG. 11.

FIG. 14 is a plan view of tray of FIG. 3 with half-moon diecuts in the bottom area of the tray cut using the die of FIG. 11.

FIG. 15 is a plan view of tray of FIG. 5 with half-moon diecuts in the bottom area of the tray cut using the die of FIG. 11.

FIG. 16 is a plan view of tray of FIG. 6 with half-moon diecuts in the bottom area of the tray cut using the die of FIG. 11.

FIG. 17 is a plan view of tray of FIG. 7 with half-moon diecuts in the bottom area of the tray cut using the die of FIG. 11.

FIG. 18 is a plan view of tray of FIG. 8 with half-moon diecuts in the bottom area of the tray cut using the die of FIG. 11.

FIG. 19 is a plan view of tray of FIG. 9 with half-moon diecuts in the bottom area of the tray cut using the die of FIG. 11.

FIG. 20 is a plan view of tray of FIG. 10 with half-moon diecuts in the bottom area of the tray cut using the die of FIG. 11.

FIG. 21 is a plan view of another embodiment of a die having a peripheral blade and interior blades to produce a circular tray blank with a plurality of straight, transversely oriented and radially arranged diecuts.

FIG. 22 is a plan view of another embodiment of a die having a peripheral blade and interior blades to produce a circular tray blank with a plurality of curved, radially arranged diecuts.

FIG. 23 is a plan view of another embodiment of a die having a peripheral blade and interior blades to produce a circular tray blank with a plurality of straight, radially oriented and radially arranged diecuts.

FIG. 24 is a plan view of another embodiment of a paper-based bakeable tray.

FIG. 24A is a partial cross-sectional view of the embossed paper-based bakeable tray of

FIG. 24 as viewed along lines A-A of FIG. 24.

FIG. 25 is a plan view of another embodiment of a paper-based bakeable tray.

FIG. 25A is a partial cross-sectional view of the embossed paper-based bakeable tray of

FIG. 25 as viewed along lines A-A of FIG. 25.

FIG. 26 is a plan view of another embodiment of a die having a peripheral blade to produce a circular tray blank, interior blades to produce a plurality of diecuts and tab blades to produce retaining tabs; each of the diecuts having the same orientation.

FIG. 27 is a plan view of another embodiment of a paper-based bakeable tray.

FIG. 27A is a partial cross-sectional view of the embossed paper-based bakeable tray of FIG. 27 as viewed along lines A-A of FIG. 27.

FIG. 27B is an enlarged view showing a retaining tab in the upwardly folded position.

### DESCRIPTION

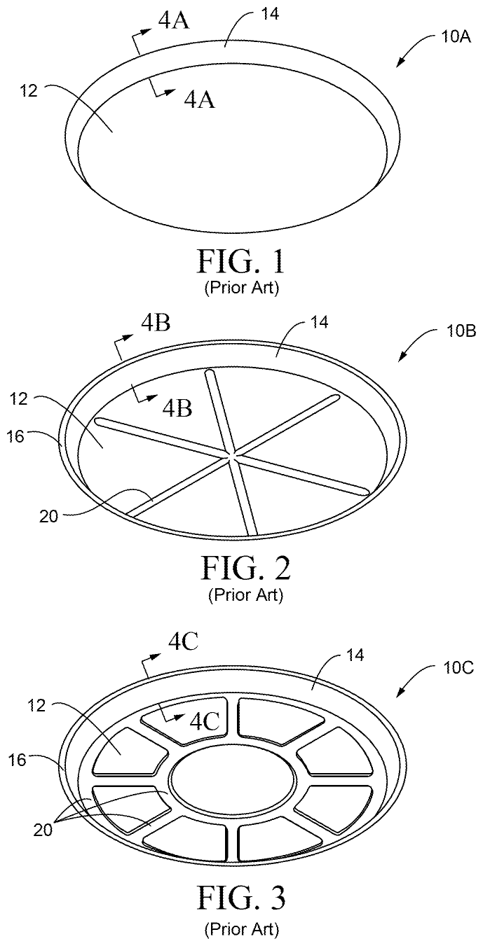

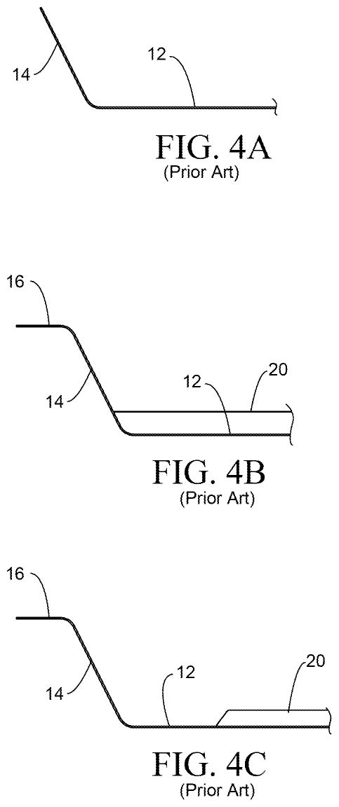

Referring to the drawings, wherein like reference numerals designate identical or corresponding parts throughout the several views, FIGS. 1-3 illustrate conventional paper-based bakeable trays 10A-10C (collectively, “conventional trays” 10). Each of the conventional trays 10 includes a bottom area 12 and a peripheral sidewall 14 as best illustrated in the partial cross-sectional view of FIG. 4. The peripheral sidewall 14 may include a circumferential lip 16.

In FIG. 1, the conventional tray 10A has a bottom area 12 that is generally flat or planar. As best shown in the cross-section of FIG. 4A as viewed along lines 4A-4A of FIG. 1, the peripheral sidewall 14 does not include a circumferential lip 16. The tray 10A may include a circumferential lip 16 such as shown in FIGS. 4B-4C. In FIG. 2, the conventional tray 10B is shown as having a bottom area 12 with raised contour surfaces 20 in the shape of a pinwheel pattern. As best shown in the cross-section of FIG. 4B as viewed along lines 4B-4B of FIG. 2, the tray 10B includes a peripheral sidewall 14 with a circumferential lip 16. The tray 10B may omit the circumferential lip 16 such as shown in FIG. 4A. In FIG. 3, the conventional tray 10C is shown as having a bottom area 12 with raised contour surfaces 20 defining a generally circular central area and eight trapezoidal areas around the central area (hereinafter referred to as “octagonal pattern”). As best shown in the cross-section of FIG. 4C as viewed along lines 4C-4C of FIG. 3, the tray 10C includes a peripheral sidewall 14 with a circumferential lip 16. The tray 10C may omit the circumferential lip 16 such as shown in FIG. 4A. The raised contour surfaces 20 shown in FIGS. 2 and 3 are non-limiting examples, as the raised contour surfaces 20 may be of any desired pattern or shape.

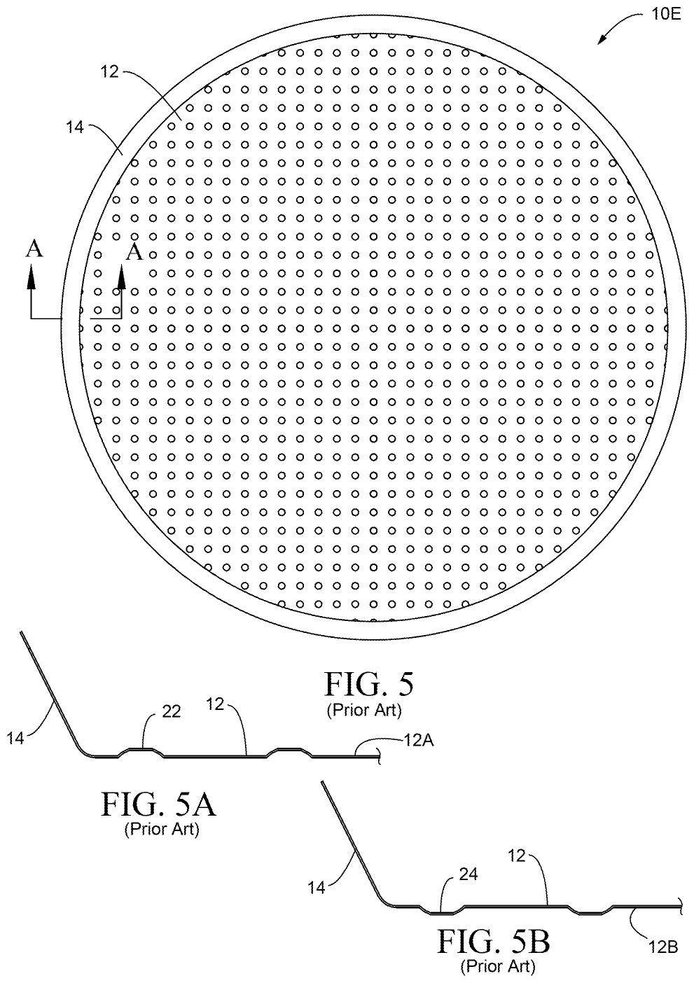

FIG. 5 illustrates another paper-based bakeable tray 10D similar to the tray 10A, but incorporating an embossed pattern formed in the bottom area 12. The term “embossed pattern” should be understood as being distinct from the raised contour surfaces 20 as depicted in FIGS. 2 and 3 and consists of a series of relatively small projections intermittently spaced over a substantial portion of the bottom area 12. The projections consisting of the embossed pattern may extend upwardly relative to a top planar surface 12A (“upward projections” 22) or the projections may extend downwardly relative to a bottom planar surface 12B (“downward projections” 24), or the projections may comprise both upward projections 22 and downward projections 24. The upward projections 22 and/or downward projections 24, or both projections 22, 24, may be formed by stamping, imprinting, pressing or other forming process. The projections 22, 24 may be any suitable configuration, size and spacing. As a non-limiting example, the projections may have a diameter of about 3/16 inch, and a height range between about 0.010 to about 0.040 inches, with a center-to-center spacing of about 1/2 inch. It should be appreciated, however, that the projections need not be round or circular and may have any desired size or shape, including any polygonal shape with widths and lengths or diameters between about ⅛ inch to about 1 inch, and may be spaced at distances ranging from about ⅜ inch to about 2 inches depending on the size of the projections.

The upward projections 22 serve to intermittently support the food product above the top planar surface 12A so as to provide an air space between an underside of the food product and the top planar surface 12A, thereby allowing air circulation below the food product so the food does not become soggy due to the collection of condensation, drippings or juices from the food as it is being cooked or after cooking. The upward projections also provide an air space which minimizes heat transfer via conduction thereby keeping the food warmer for a longer period of time. With the embossed trays having both upward projections 22 and downward projections 24, the downward projections 24 or depressions form an intermittent lower support surface provide an air space permitting air circulation between the plurality of downward projections. The downward projections 24 also serve as small wells below the food product in which condensation, food juices or drippings are collected.

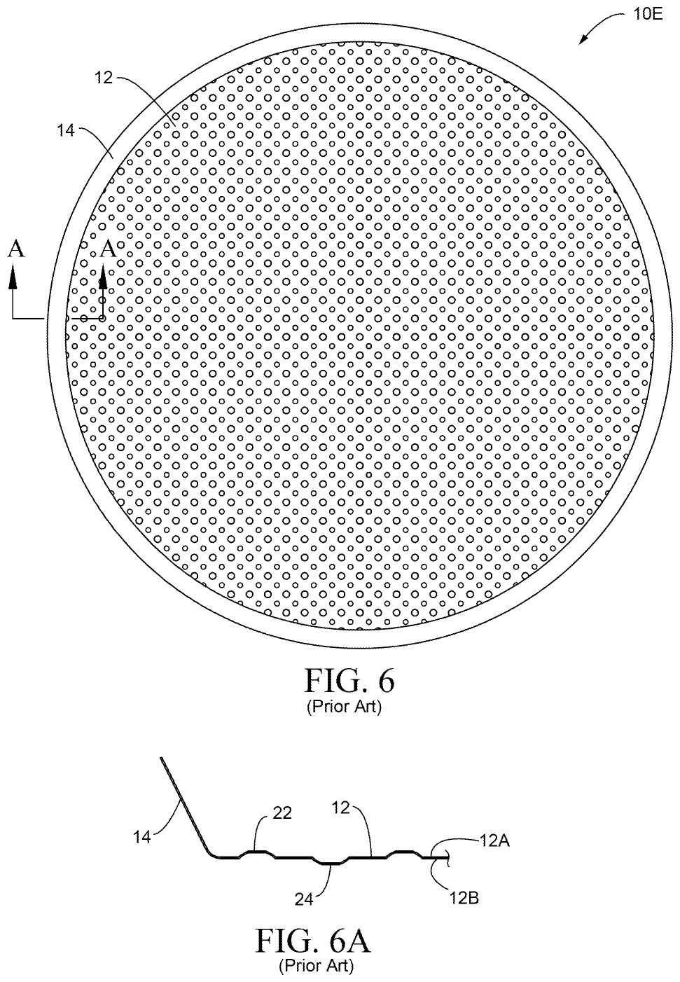

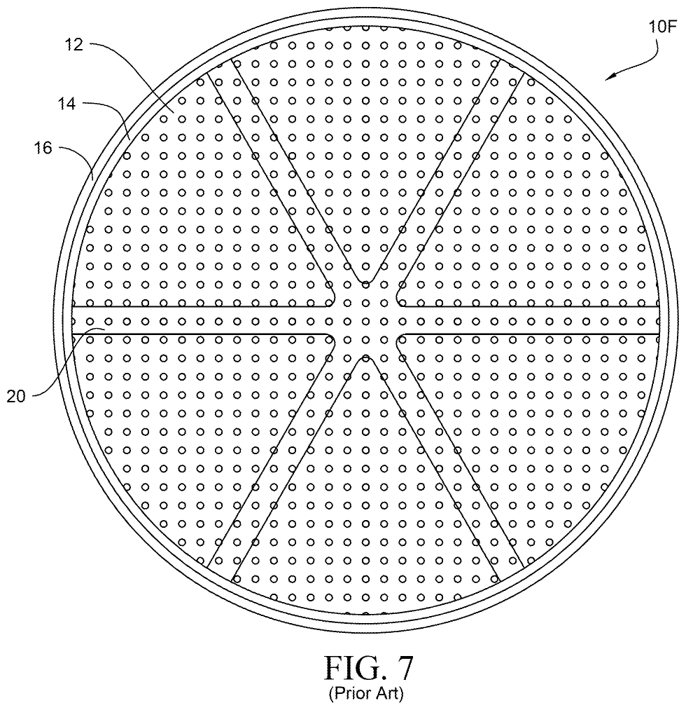

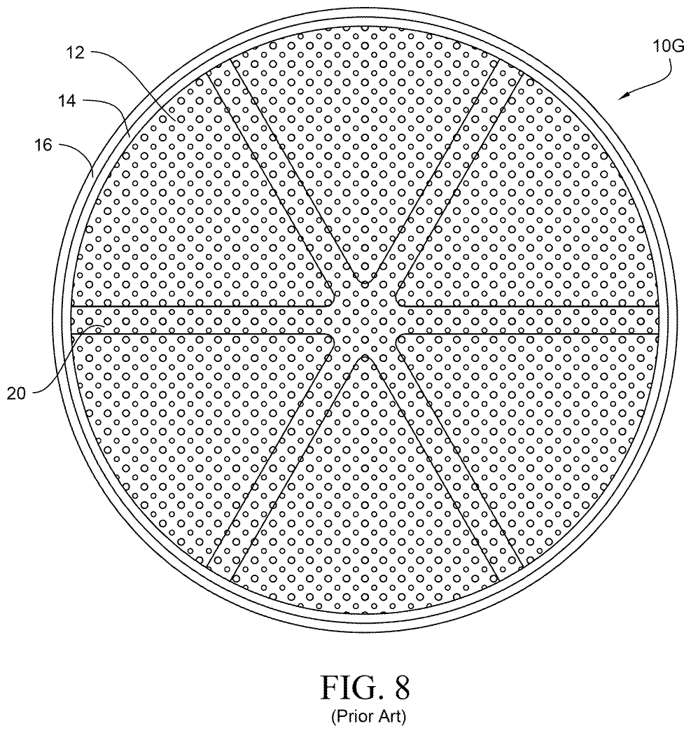

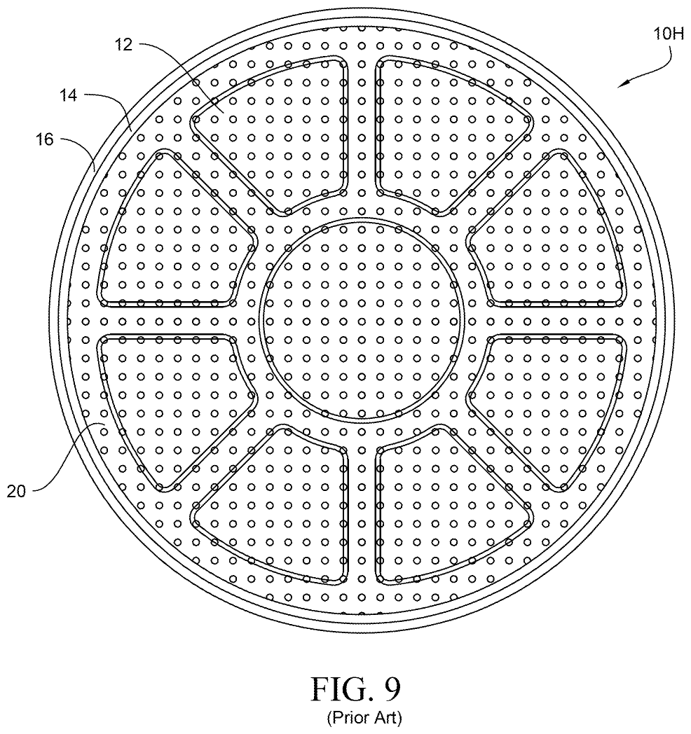

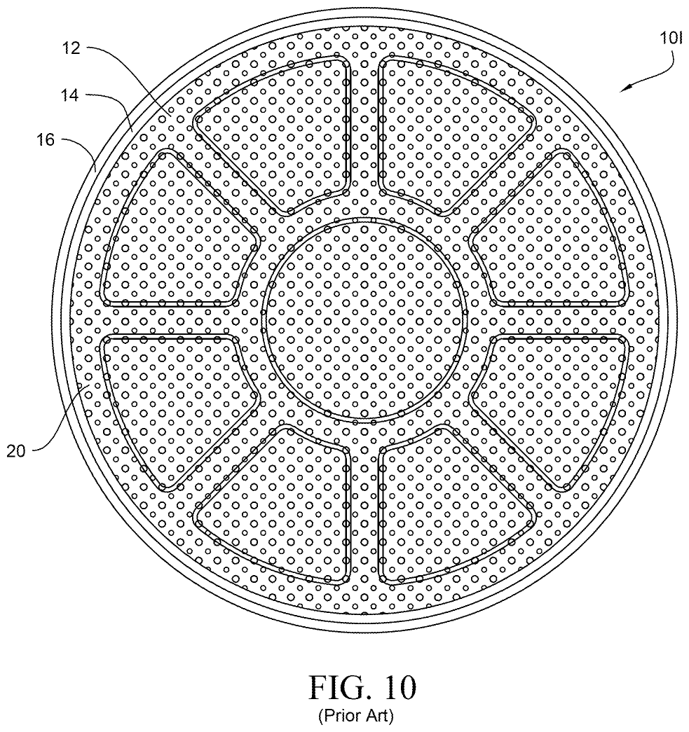

In FIG. 5, the embossed pattern of the paper-based bakeable tray 10D is shown as comprising only upward projections 22 or only downward projections 24. FIG. 6 illustrates another paper-based bakeable tray 10E similar to the tray 10A, but incorporating an embossed pattern formed in the bottom area 12 with both upward projections 22 and downward projections 24. FIG. 7 shows yet another alternative paper-based bakeable tray 10F which includes the pinwheel shaped raised contour surfaces 20 similar to FIG. 2 in combination with an embossed pattern comprising only upward projections 22 or only downward projections 24. FIG. 8 shows yet another alternative paper-based bakeable tray 10G which includes the pinwheel shaped raised contour surfaces 20 similar to FIG. 2 in combination with an embossed pattern comprising both the upward projections 22 and the downward projections 24. FIG. 9 shows yet another alternative paper-based bakeable tray 10H which includes the raised contour surfaces 20 arranged in the octagonal pattern similar to FIG. 3 in combination with an embossed pattern that comprises only upward projections 22 or only downward projections 24. FIG. 10 shows yet another paper-based bakeable tray 10I which includes the raised contour surfaces 20 are arranged in the octagonal pattern similar to FIG. 3 in combination with an embossed pattern that comprises both the upward projections 22 and the downward projections 24. The embossed patterns in the examples of FIGS.

7-10 shows the projections 22, 24 formed in the raised contour surfaces 20 as well as the bottom area between the raised contour surfaces 20, but is should be appreciated that the embossed pattern may be formed only in the bottom area between the raised contour surfaces 20, or only within the raised contour surfaces 20.

It has been found that paper-based bakeable trays having embossed patterns as described herein improves the quality of certain foods when reheating or baking, due to the projections creating an air space and allowing more air circulation below the food. For example it has been found that if a conventional flat bottomed (non-embossed) paper-based bakeable tray such as shown in FIG. 1 is formed with an embossing pattern as described herein and illustrated in FIG. 5 or 6, and if these embossed trays 10D and 10E are then used to bake pizza, the resulting pizza crust is more uniformly cooked, is crispier and has a more uniform golden-brown crust. It was also found that if a black colored, conventional flat bottomed (non-embossed) paper based bakeable tray such as shown in FIG. 1 is formed with an embossing pattern as described herein and illustrated in FIG. 5 or 6, and if these black colored embossed trays 10D and 10E are then used to bake pizza, the resulting pizza crust is even crispier and more golden-brown. The same holds true for the paper-based bakeable trays having the raised contour surfaces 20, such as shown in FIGS. 2 and 3 when formed with an embossing patterns as described and illustrated in FIGS. 7 to 10.

It has also been found, however, that even when incorporating the embossing pattern into the trays as illustrated in FIGS. 5-10, the desired quality and crispness of some foods may still not be achieved. Applicant has found that the crispiness and quality of the food can be improved by incorporating diecuts 110 into the bottom area 12, and optionally into the sidewall 14 of the trays.

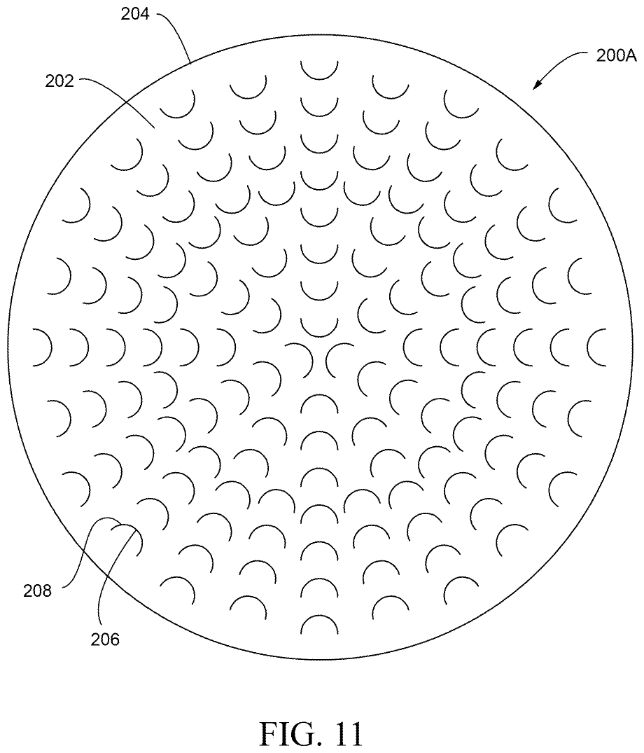

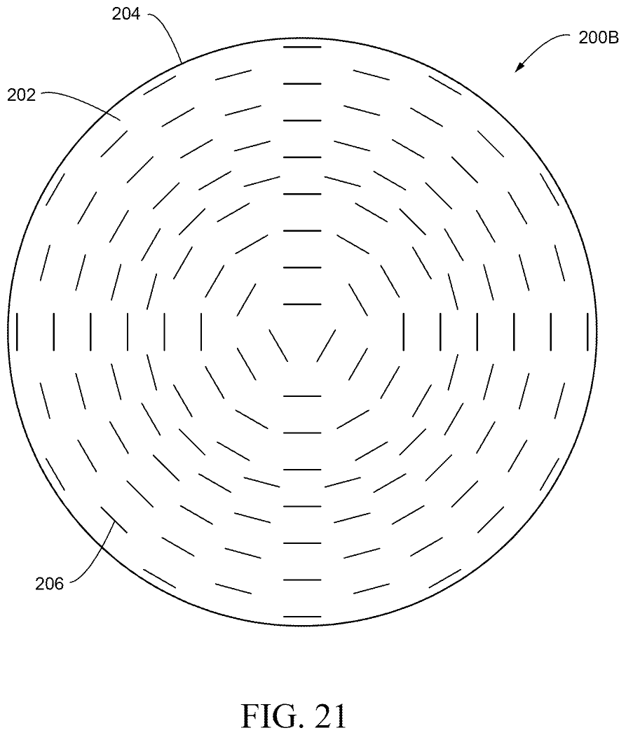

FIG. 11 illustrates one embodiment of a die 200A for use with a platen press for cutting tray blanks which are then formed into trays using a thermoforming process discussed later. FIGS. 21-23 and 26 illustrate alternative embodiments of dies 200B-200E. In each of the embodiments, the dies 200A-200E (collectively dies 200), include a base area 202 defined by a peripheral blade 204 for cutting the outer shape of the tray blank. Within the base area 202 of the dies 200 are a plurality of interior blades 206 configured to produce the diecuts 110 in the form of slits or cuts in the bottom area 12 of the tray blanks and optionally in the sidewalls of the tray blanks.

In the embodiment of FIG. 11, the interior blades 206 are shown as being arced or half-mooned shaped with the arced edge 208 oriented toward the center of the die 200 and with each of the interior blades 206 arranged in a generally radial pattern. It should be appreciated that the shape and pattern of the blades 206, will result in half-moon shaped diecuts 110 in the tray blanks with a rounded cut edge 113 oriented toward the center of the tray blanks. This rounded shape and orientation of the blades 206 and resulting diecuts 110 in the trays has been found to be beneficial when removing the cooked food (such as a slice of cooked pizza) from the tray 100 with a spatula because the rounded cut edges 113 and radial orientation of the diecuts 110 are less likely to catch the edge of the spatula within one of the diecuts 110 when the spatula is inserted between the food and the tray.

FIG. 21 is a plan view of another embodiment of a die 200B for cutting a tray blank. In this embodiment, the blades 206 are straight and are transversely oriented relative to radial, but the straight blades are arranged in a radial pattern resulting in a tray blank with a plurality of straight, transversely oriented and radially arranged diecuts 110 in the tray blanks.

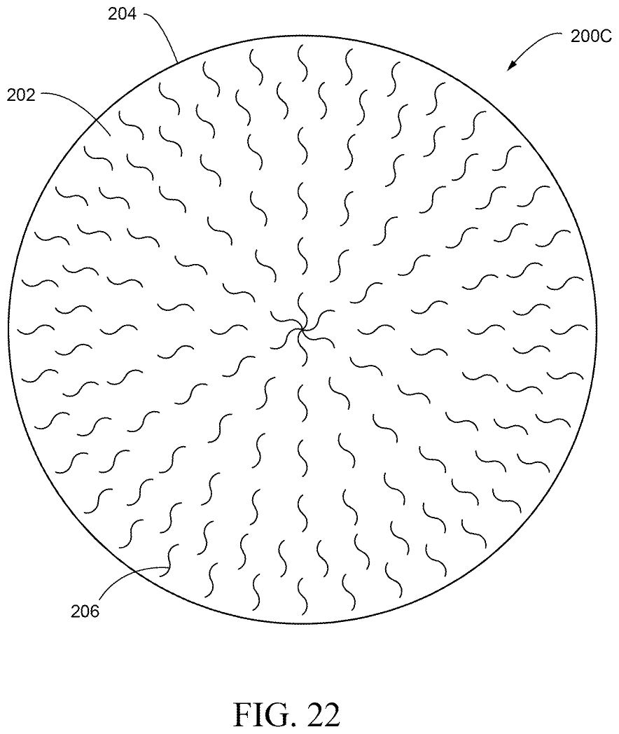

FIG. 22 is a plan view of another embodiment of a die 200C for cutting a tray blank. In this embodiment, the interior blades 206 are S-shaped and are radially oriented resulting in a tray blank with a plurality of S-shaped, radially arranged diecuts 110 in the tray blanks.

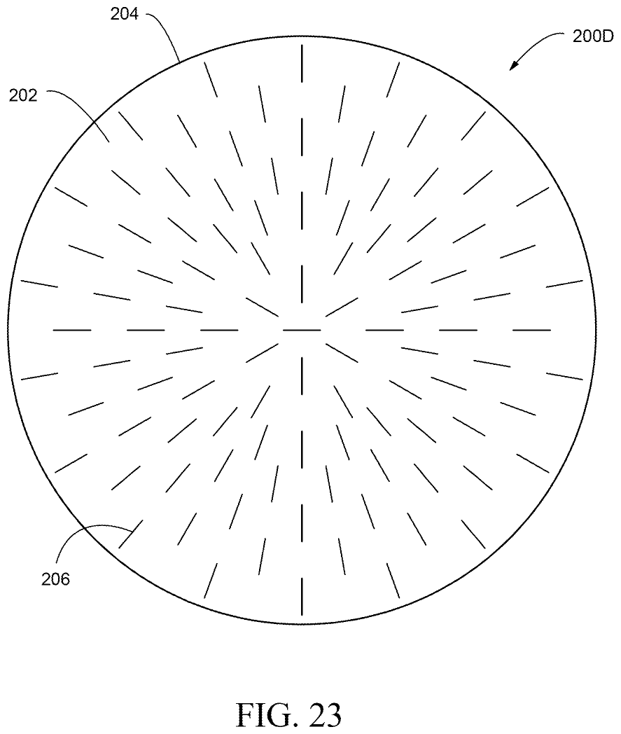

FIG. 23 is a plan view of another embodiment of a die 200D for cutting a tray blank. In this embodiment, the interior blades 206 are straight and radially oriented and radially arranged resulting in straight and radially oriented and radially arranged diecuts 110 in the tray blanks.

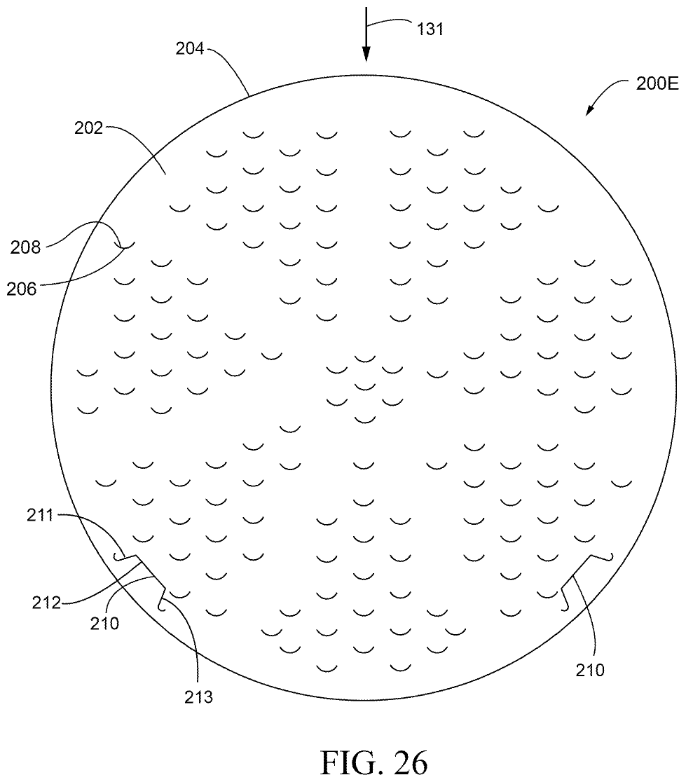

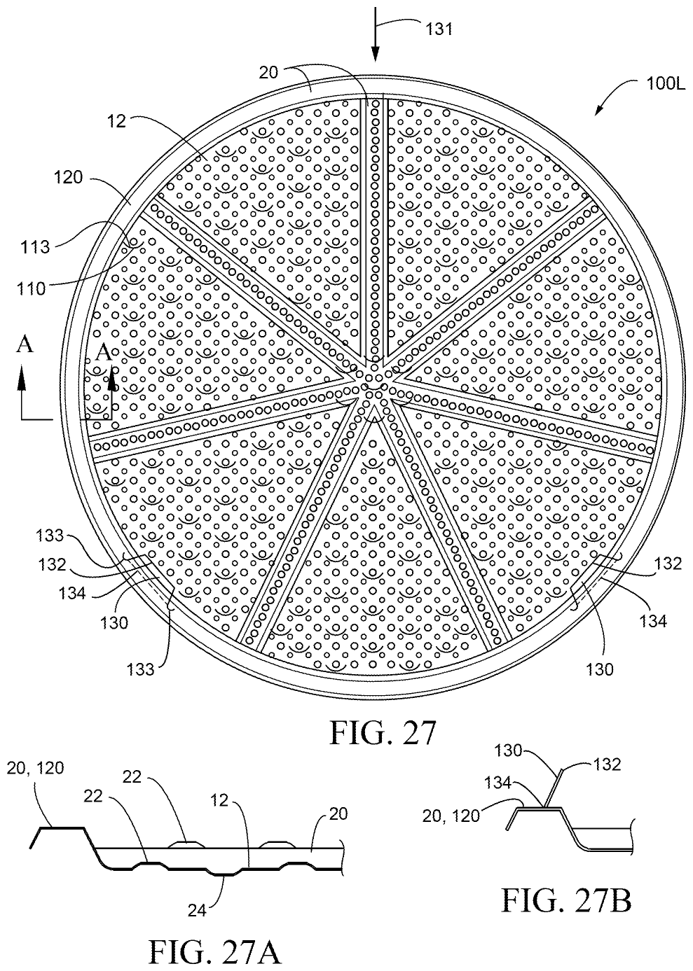

FIG. 26 is a plan view of another embodiment of a die 200E for cutting a tray blank. In this embodiment, the interior blades 206 are again shown as being arced or half-mooned shaped with an arced edge 208. In this embodiment, the arced edges 208 are all oriented in the same direction as arrow 131 so as to form diecuts 110 in the tray blanks with the rounded cut edge 113 oriented in the direction of arrow 131. In this embodiment, the interior blades 206 are positioned in a pattern for a tray intended to have raised contour surfaces 20 in a seven-spoke pinwheel pattern as shown in the tray 100L of FIG. 27 (discussed later), such that the diecuts 110 in the tray 100L are positioned between each of the raised contour surfaces 20 of the seven-spoke pinwheel and at the center of the pinwheel pattern. In this embodiment, the die 200E also includes tab blades 210 to cut retaining tabs 130 in the tray at about the 4:30 and 7:30 o′clock positions (as viewed in FIG.

26) for reasons discussed in connection with FIG. 27. The tab blade 210 is shown as having a three edges 211, 212, 213 arranged to produce a three-sided retaining tab 130 that can be folded upwardly along a foldline 134 (FIG. 27) for reasons discussed in connection with FIG. 27. The outward ends of the blade edges 211, 213 may be hooked to produce J-shaped cuts 133 (FIG. 27) to prevent or minimize tearing of the tray at the foldline 134 of the tabs 130. It should be appreciated that instead of the tab blades 210 have a three edges 211, 212, 213 the tab blades 210 may have a single arcuate blade edge to produce a rounded tab, or two blade edges to produce a triangular tab, or any other blade edge configured for cutting a retaining tab 130 of any desired shape. Likewise, the tab blades 210 may be positioned in other desired locations. For example, instead of two tab blades 210 positioned at about the 4:30 and 7:30 o′clock positions as shown in

FIG. 26, the die may have only one tab blade 210 for cutting a tab 130 positioned at about the 6:00 o′clock position as viewed in FIG. 26. Alternatively, instead of two tab blade 210, the die may include three or more tab blades 210 positioned for cutting three or more retaining tabs 130 in the tray at desired locations, for example, at the 3:00, 6:00 and 9:00 o′clock positions as viewed in FIG. 26. It should also be appreciated, that each of the dies 200A-200D, may include one or more tab blades 210.

The various embodiments of the dies 200A-200E are non-limiting examples. While the base area 202 and peripheral blade 204 are shown as being circular for producing a circular tray blank, the shape of the base area 202 and peripheral blade 204 may be rectangular, triangular, or any other desired shape for cutting the tray blank to be subsequently thermoformed into a respective rectangular, triangular or other shape tray that may be desired for the food product to be received in the tray. Additionally, the size, shape and number of interior blades 206 may vary depending on the size of the tray to be formed and the type of food product to be cooked on the tray. It should also be appreciated that rather than the blades 206 being arced, curved or straight to produce the diecuts 110 in the form of slits, in some embodiments it may be desirable to include interior blades 206 which produce open slots or open holes or other shaped open apertures in the tray blanks. It should also be appreciated that if it is desired to produce a tray with the diecuts 110 in the sidewalls 14 of the trays 100, the interior blades 206 will be closer to the peripheral blade 204 such that when the peripheral sidewall 14 of the tray is thermoformed, the diecuts would be cut in the formed peripheral wall 14.

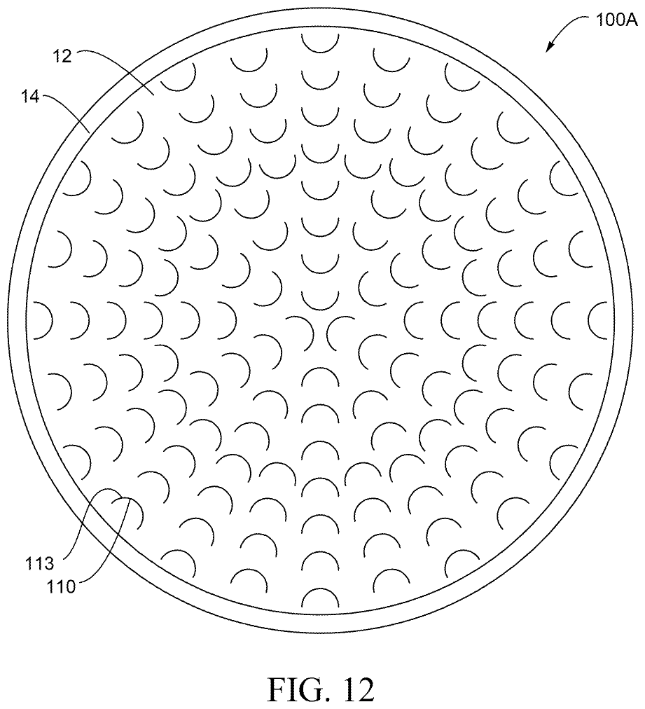

FIGS. 12-20 illustrate trays 100A-100I formed from the tray blanks produced using the die 200A of FIG. 11 (i.e., with the half-moon shaped interior blades 206). While the drawings do not illustrate trays or tray blanks produced with the alternative example embodiments of the dies 200B-200E, the resulting trays produced with any of the die embodiments 200B-200E would be evident to a person of ordinary skill in the art based on the trays 100A-100I of FIGS. 12-20 illustrated as being produced from the tray blanks cut using the die 200A of FIG. 11.

FIG. 12 illustrates one embodiment of a tray 100A that is substantially the same as the conventional tray 10A of FIG. 1, but incorporating a plurality of diecuts 110 in the bottom area 12 of the tray 100A and optionally into the sidewall 14 using the die 200A of FIG. 11. As with the conventional tray 10A, the tray 100A is shown with a sidewall 14 without a circumferential lip 16, but the tray 100A may include a circumferential lip 16 such as shown in FIGS. 2-3 and 4B-4C.

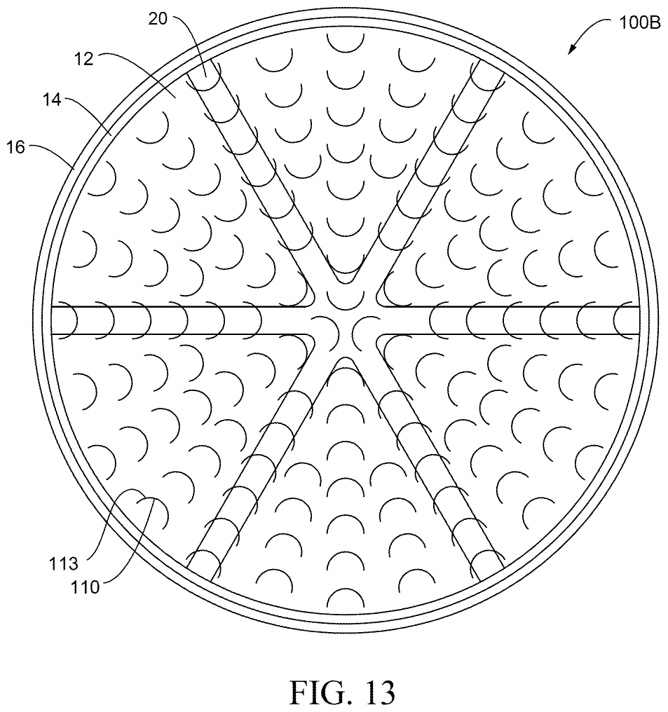

FIG. 13 illustrates another embodiment of a tray 100B that is substantially the same as the conventional tray 10B of FIG. 2, but incorporating a plurality of diecuts 110 in the bottom area 12 of the tray 100B and optionally into the sidewall 14 using the die 200A of FIG. 11. As with the conventional tray 10B, the tray 100B is shown with a sidewall 14 having a circumferential lip 16, but the tray 100B may omit the circumferential lip 16 such as shown in FIGS. 1 and 4A. As with the conventional tray 10B, the tray 100B includes raised contour surfaces 20 formed in the bottom area 12 of the tray 100B in the shape of a pinwheel pattern.

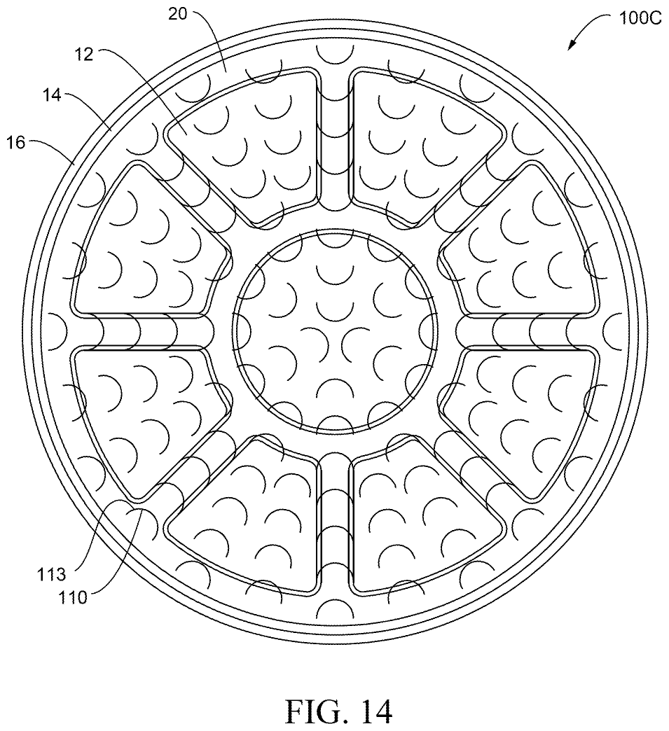

FIG. 14 illustrates another embodiment of a tray 100C that is substantially the same as the conventional tray 10C of FIG. 3, but incorporating a plurality of diecuts 110 in the bottom area 12 of the tray 100C and optionally into the sidewall 14 using the die 200A of FIG. 11. As with the conventional tray 10C, the tray 100C is shown with a sidewall 14 having a circumferential lip 16, but the tray 100C may omit the circumferential lip 16 such as shown in FIGS. 1 and 4A. As with the conventional tray 10C, the tray 100C includes raised contour surfaces 20 formed in the bottom area 12 of the tray 100C with the octagonal pattern.

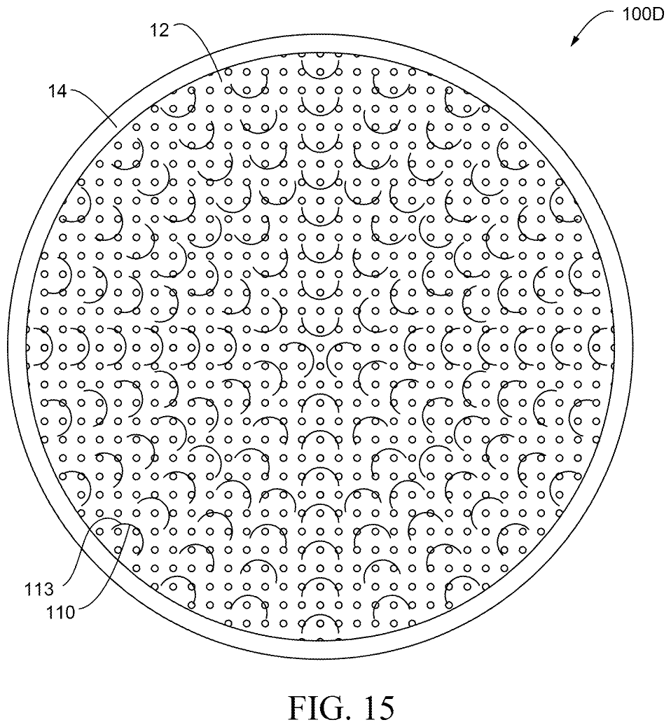

FIG. 15 illustrates another paper-based bakeable tray 100D substantially the same as the conventional tray 10D of FIG. 5, but incorporating a plurality of diecuts 110 in the bottom area 12 of the tray 100D and optionally into the sidewall 14 using the die 200A of FIG. 11. As with the conventional tray 10D, the tray 100D includes a peripheral sidewall 14 without a circumferential lip 16, but the tray 100D may include a circumferential lip 16 such as shown in FIGS. 2-3 and 4B-4C. As with the conventional tray 10D, the tray 100D includes an embossed pattern shown as comprising only upward projections 22 or only downward projections 24.

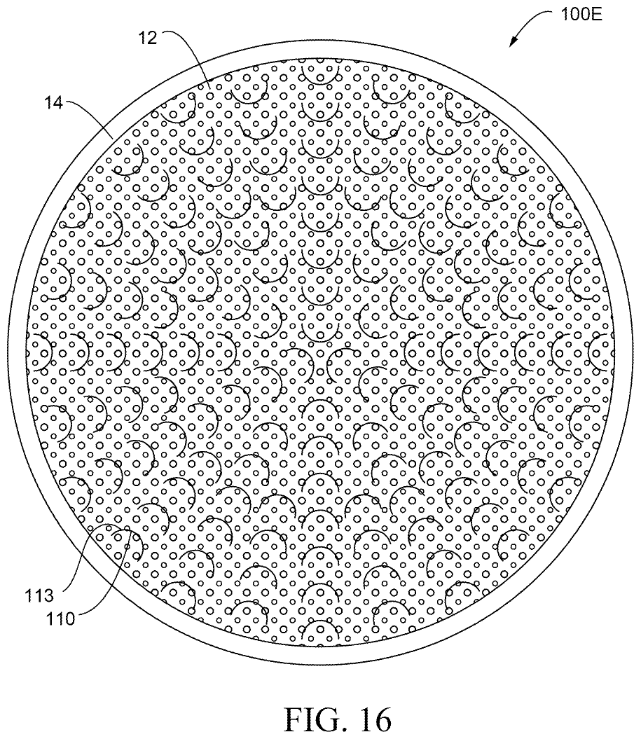

FIG. 16 illustrates another paper-based bakeable tray 100E substantially the same as the conventional tray 10E of FIG. 6, but incorporating a plurality of diecuts 110 in the bottom area 12 of the tray 100E and optionally into the sidewall 14 using the die 200A of FIG. 11. As with the conventional tray 10E, the tray 100E includes a peripheral sidewall 14 without a circumferential lip 16, but the tray 100E may include a circumferential lip 16 such as shown in FIGS. 2-3 and 4B-4C. As with the conventional tray 10E, the tray 100E includes an embossed pattern comprising both the upward projections 22 and the downward projections 24.

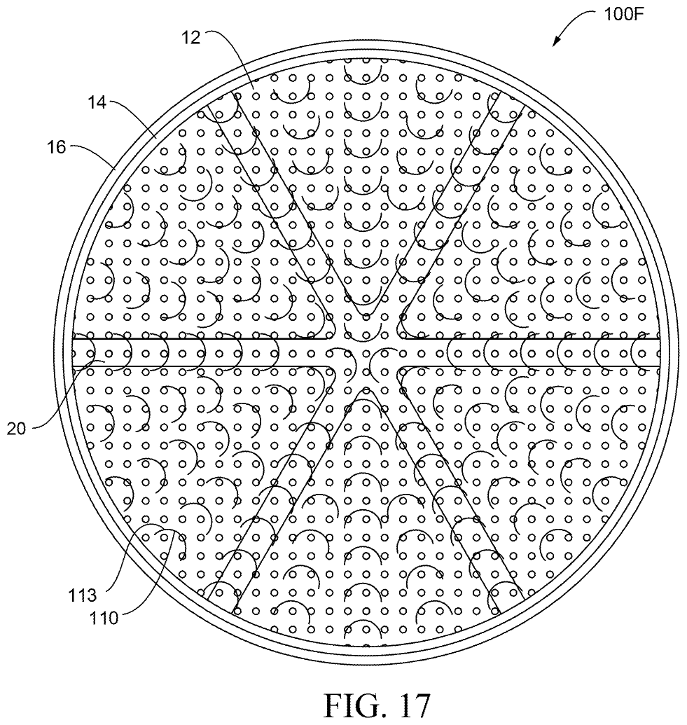

FIG. 17 illustrates another embodiment of a tray 100F that is substantially the same as the conventional tray 10F of FIG. 7, but incorporating a plurality of diecuts 110 in the bottom area 12 of the tray 100F and optionally into the sidewall 14 using the die 200A of FIG. 11. As with the conventional tray 10F, the tray 100F is shown with a sidewall 14 having a circumferential lip 16, but the tray 100F may omit the circumferential lip 16 such as shown in FIGS. 1 and 4A. As with the conventional tray 10F, the tray 100F includes raised contour surfaces 20 formed in the bottom area 12 of the tray 100F in the shape of a pinwheel pattern. Also, as with the conventional tray 10F, the tray 100F includes an embossed pattern shown as comprising only upward projections 22 or only downward projections 24.

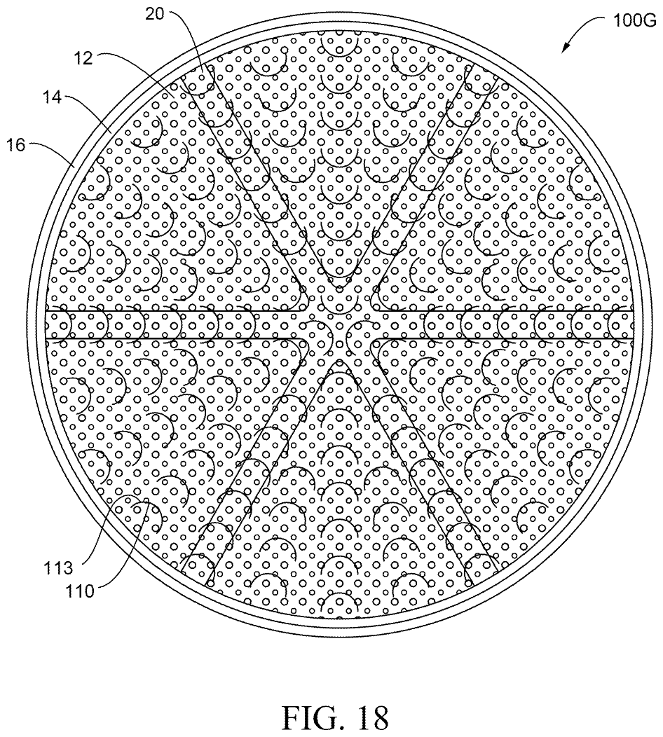

FIG. 18 illustrates another embodiment of a tray 100G that is substantially the same as the conventional tray 10G of FIG. 8, but incorporating a plurality of diecuts 110 in the bottom area 12 of the tray 100G and optionally into the sidewall 14 using the die 200A of FIG. 11. As with the conventional tray 10G, the tray 100G is shown with a sidewall 14 having a circumferential lip 16, but the tray 100G may omit the circumferential lip 16 such as shown in FIGS. 1 and 4A. As with the conventional tray 10G, the tray 100G includes raised contour surfaces 20 formed in the bottom area 12 of the tray 100G in the shape of a pinwheel pattern. Also, as with the conventional tray 10G, the tray 100G includes an embossed pattern shown as comprising both upward projections 22 and downward projections 24.

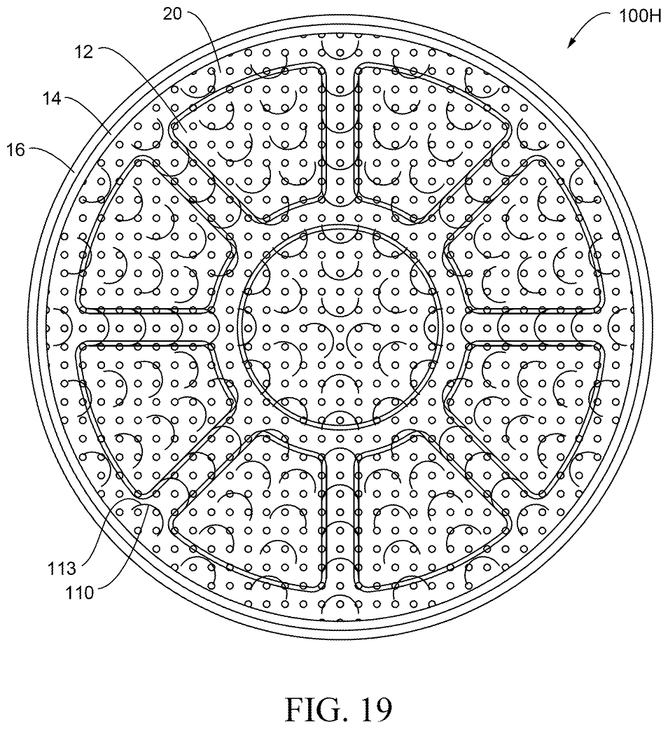

FIG. 19 illustrates another embodiment of a tray 100H that is substantially the same as the conventional tray 10H of FIG. 9, but incorporating a plurality of diecuts 110 in the bottom area 12 of the tray 100H and optionally into the sidewall 14 using the die 200A of FIG. 11. As with the conventional tray 10H, the tray 100H is shown with a sidewall 14 having a circumferential lip 16, but the tray 100H may omit the circumferential lip 16 such as shown in FIGS. 1 and 4A. As with the conventional tray 10H, the tray 100H includes raised contour surfaces 20 formed in the bottom area 12 of the tray 100H with the octagonal pattern. Also, as with the conventional tray 10H, the tray 100H includes an embossed pattern shown as comprising only upward projections 22 or only downward projections 24.

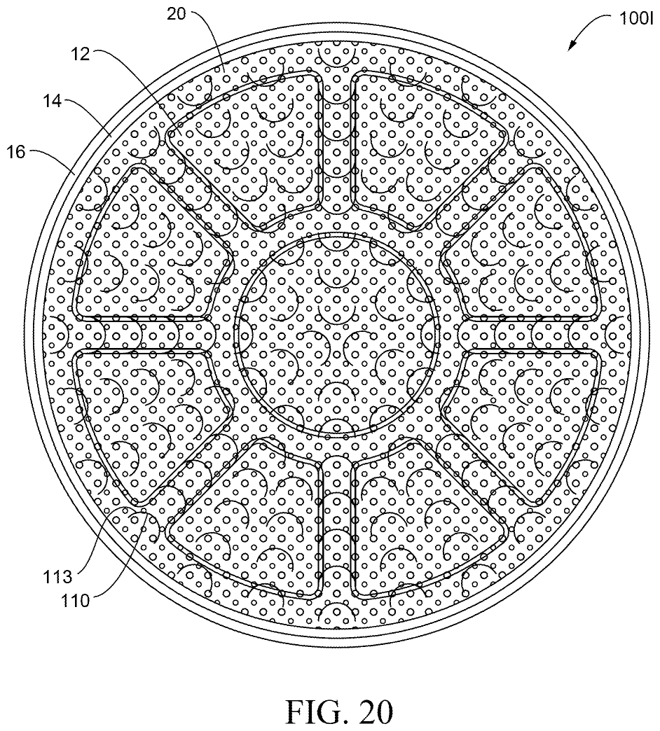

FIG. 20 illustrates another embodiment of a tray 100I that is substantially the same as the conventional tray 10I of FIG. 10, but incorporating a plurality of diecuts 110 in the bottom area 12 of the tray 100I and optionally into the sidewall 14 using the die 200A of FIG. 11. As with the conventional tray 10I, the tray 100I is shown with a sidewall 14 having a circumferential lip 16, but the tray 100I may omit the circumferential lip 16 such as shown in FIGS. 1 and 4A. As with the conventional tray 10I, the tray 100I includes raised contour surfaces 20 formed in the bottom area 12 of the tray 100I with the octagonal pattern. Also, as with the conventional tray 10I, the tray 100I includes an embossed pattern shown as comprising both upward projections 22 and downward projections 24.

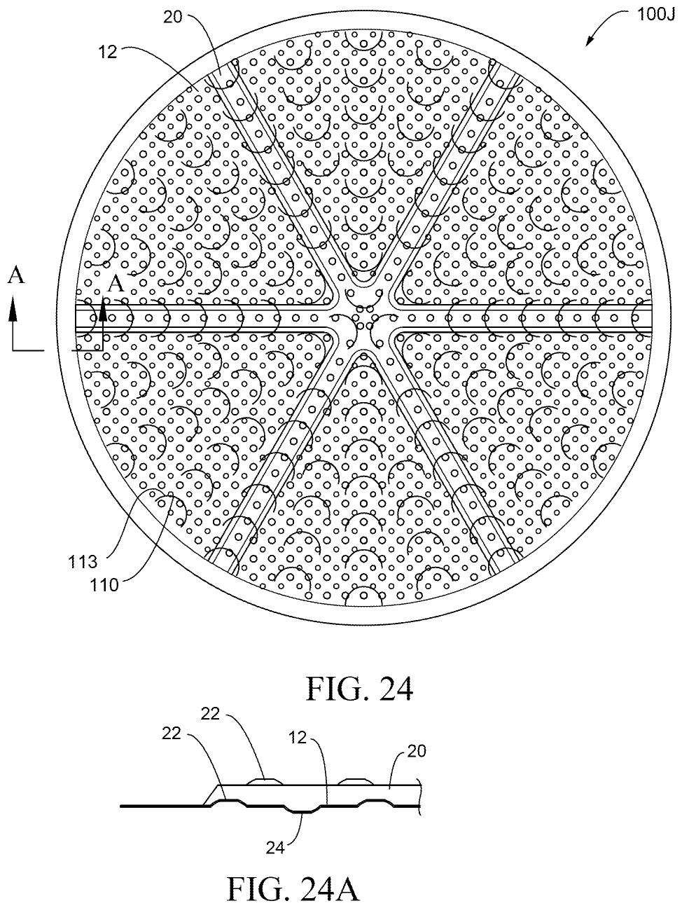

FIG. 24 illustrates another embodiment of a tray 100J. FIG. 24A is an enlarged cross-sectional view along lines A-A of FIG. 24. Unlike the previous embodiments, the tray 100J does not include a peripheral sidewall 14. Instead, the tray 100J is substantially a flat sheet with diecuts 110 over the bottom surface area 12 and with the bottom surface area having an embossed pattern. The tray 100J is shown as having raised contour surfaces 20 in the form of a pinwheel pattern in the bottom surface area 12 similar to FIG. 2 . Instead of the contour surfaces 20 being in the form of a pinwheel pattern, the raised contour surfaces 20 may be in the form of the octagonal pattern similar to FIG. 3 or any other desired shape or pattern. Alternatively, the tray 100J need not have any raised contour surfaces 20 such that the tray 100J may be an embossed flat sheet with diecuts 110 over the bottom surface 12. In the embodiment shown, the embossed pattern of the tray 100J includes both upward projections 22 and downward projections 24 over the bottom surface 12 between the pinwheel contour surfaces 20. The pinwheel shaped raised contour surfaces 20 are shown as having only upward projections 22 arranged radially along the spokes of the pinwheel pattern. It should be appreciated that the embossed pattern may include only upward projections 22 or only downward projections 24 in any pattern, and the embossed pattern may be a combination of both upward projections 22 and downward projections arranged in any pattern.

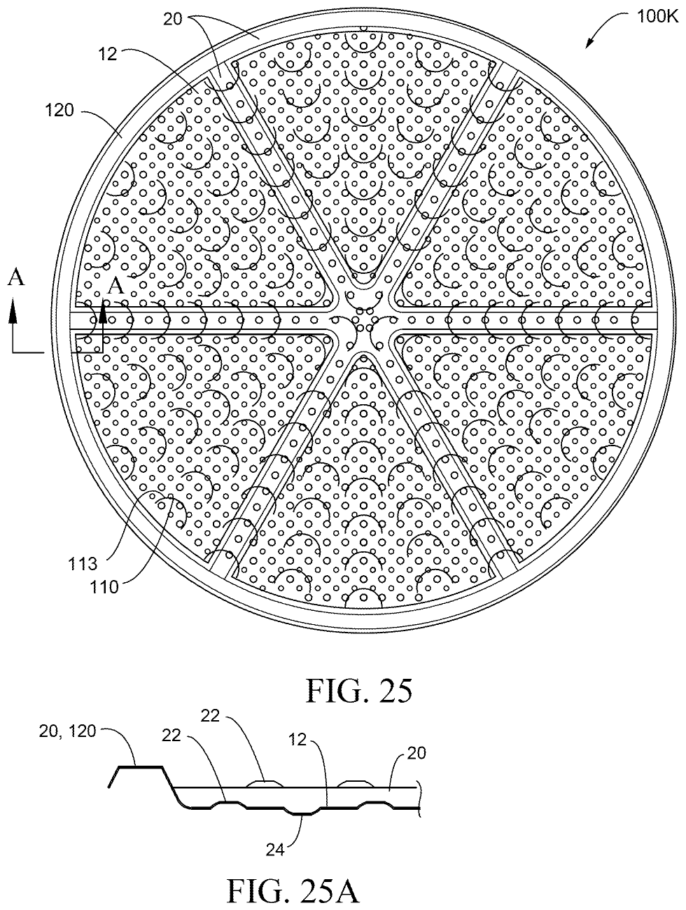

FIG. 25 illustrates another embodiment of a tray 100K. FIG. 25A is an enlarged cross-sectional view along lines A-A of FIG. 25. Tray 100K is substantially the same as tray 100J except that tray 100K also includes a raised contour surface 20 around its outer periphery forming a peripheral rib 120 for added rigidity.

FIG. 27 illustrates another embodiment of a tray 100L produced using the die 200E of FIG. 26. As best illustrate in FIG. 27A, the tray 100L includes a raised contour surface 20 around its outer periphery forming a peripheral rib 120 for added rigidity. The tray 100L is shown as having raised contour surfaces 20 in the form of a seven-spoke pinwheel pattern in the bottom surface area 12. Instead of the contour surfaces 20 being in the form of a pinwheel pattern, the raised contour surfaces 20 may be in the form of the octagonal pattern similar to FIG. 3 or any other desired shape or pattern. Alternatively, the tray 100L need not have any raised contour surfaces 20 such that the tray 100L may be an embossed flat sheet with diecuts 110 over the bottom surface 12. In the embodiment shown, the embossed pattern of the tray 100J includes both upward projections 22 and downward projections 24 over the bottom surface 12 between the pinwheel contour surfaces 20. The pinwheel shaped raised contour surfaces 20 are shown as having only upward projections 22 arranged radially along the spokes of the pinwheel pattern. It should be appreciated that the embossed pattern may include only upward projections 22 or only downward projections 24 in any pattern, and the embossed pattern may be a combination of both upward projections 22 and downward projections arranged in any pattern. In this embodiment, the diecuts 110 are all oriented in one direction with the curved edge 113 in the same direction as arrow 131. The diecuts 110 are positioned only between each of the spokes of the seven-spoked pinwheel pattern and around the center of the pinwheel. The tray 100L includes the retaining tabs 130 which may be folded upward along foldline 134 such that the free end 132 of the retaining tab 130 projects upwardly as shown in FIG. 27B. It should be appreciated that retaining tabs 130 are positioned at about the 4:30 and 7:30 o′clock position (as viewed in FIG. 27) such that when an uncooked pizza (or other food product) is placed on the tray 100L and is then slid into the oven in the direction of arrow 131 for cooking, the upwardly folded retaining tabs 130 hold the pizza (or other food product) in place, preventing it from sliding off the tray 100L. Likewise, because the diecuts 110 are oriented with the rounded cut edge 113 in the direction of arrow 131, when the pizza peel or paddle is being inserted into the oven in the direction of arrow 131 to remove the cooked pizza (or other food product) from the oven, the pizza peel or paddle will slip under the diecuts 110 without catching on the cut edges 113 which may otherwise occur if the rounded cut edges 113 were curved toward the arrow 131.

The raised contour surfaces 20 of trays 100B, 100C and 100F-100L shown in FIGS. 13-14, 17-20, 24, 25 and 27, are non-limiting examples and it should be appreciated that the raised contour surfaces 20 may be any desired pattern or shape. It should also be appreciated that the embossed pattern described in connection with trays 100D-100L of FIGS. 15-20, 24, 25 and 27 consists of a series of relatively small projections intermittently spaced over a substantial portion of the bottom area 12. The upward projections 22 and/or downward projections 24, or both projections 22, 24 of the embossed pattern, may be formed by stamping, imprinting, pressing or other forming process. The projections 22, 24 may be any suitable configuration, size and spacing. As a non-limiting example, the projections may have a diameter of about 3/16 inch, and a height range between about 0.010 to about 0.040 inches, with a center-to-center spacing of about ½ inch.

It should be appreciated, however, that the projections 22, 24 need not be round or circular and may have any desired size or shape, including any polygonal shape with widths and lengths or diameters between about ⅛ inch to about 1 inch, and may be spaced at distances ranging from about ⅜ inch to about 2 inches depending on the size of the projections.

When producing the paper-based trays 100A-100L, after tray blanks are cut by any of the dies 200A-200E. The cut tray blanks (with the diecuts 110 and optional retaining tabs 130 cut therein) are placed on a thermoforming press having male and female thermoforming dies (not shown) having the shape and configuration to produce the tray shape and configuration desired using heat and pressure. For example the male and female thermoforming dies may be circular with mating features to produce the bottom area 12 with or without the sidewall 14, and/or with or without the circumferential lip 16. If the tray 100 is to have raised contour surfaces 20 as illustrated in FIGS. 13-14, the male die portion will include the raised surfaces and the female die portion will include mating recessed surface to form the raised contour surfaces in the trays during the thermoforming process. Likewise if the tray 100 is to include the embossed pattern with only upward projections 22, or only downward projections 24 or both upward and downward projections 22, 24, the male and female dies of the thermoforming press will include the corresponding male projections and female depressions to produce the desired embossed pattern in the trays during the thermoforming process. Likewise if the tray 100 is to include both the raised contour surfaces 20, 120 and the embossed pattern, the bottom area of the male and female dies will include raised surfaces and mating recesses to produce the raised contour surfaces 20, 120 and the male and female dies will include male projections and female depressions to produce the desired embossed pattern in the trays during the thermoforming process.

In an alternative process, the trays 100A-100L may be produced from preformed trays and the dies 200 may include the interior blades 206 and the optional tab blades 210 but without the peripheral blade 204. In such an alternative process the preformed trays are simply stamped using a platen press fitted with the alternative die (including the internal blades 206 and optional tab blades 210 without the peripheral blade 204) to stamp or cut the diecuts 110 and optional retaining tabs 130 into the preformed trays to produce the trays 100A-100L with the diecuts 110 and optional retaining tabs 130.

The trays 100 may be made of premium grade solid bleached sulfate (SBS) or any other suitable type of paper, paperboard, cardstock or cardboard material or any other type of pulp-based, fiber-based or cellulose-based material, whether from wood, other plant or natural material (collectively referred to as “paper-based” material).

Depending on the application and intended use of the trays 100 and the type of food it is intended to contact, the paper-based material from which the trays 100 are thermoformed may have barrier coatings applied or barrier materials may be incorporated into the paper-based material such that the embossed trays are suitable for baking, heating, or reheating foods and are able to withstand oven temperatures between about 150 degrees Fahrenheit and about 500 degrees Fahrenheit. Additionally, or in the alternative, the paper-based material from which the trays 100 are thermoformed may include barrier coatings or barrier materials may be incorporated into the paper-based material such that the trays are freezer-to-oven ready or such that the paper-based material is otherwise impermeable or partially impermeable to liquids. As recognized and understood by those of ordinary skill in the art, such barrier coatings or barrier materials may be applied to the paper-based material, before, during or after the thermoforming process or otherwise incorporated into the paper-based material.

It is submitted that incorporating the diecuts 110 and optional retaining tabs 130 into the trays 100 would be counterintuitive to persons of skill in the art because the conventional bakeable trays 10A-10I referenced above are typically designed to capture the grease or juices released from the food product during and after cooking which is why they are typically produced with a barrier coating to be impermeable to liquids. In fact, the raised contours 20 on the bottom area 12 of the trays 10B and 10C with or without the embossed pattern are specifically designed to create wells below the food product in which the grease or juices from the food product is collected. It has been found, however, that the diecuts 110 allow the food product to form a crust on the bottom surface more quickly which minimizes juices dripping from the food during and after cooking.

Additionally, because in the embodiments in which the diecuts 110 are merely slits or cuts in the bottom area 12 of the tray and optionally in the sidewalls 14, there will be very little escapement of any juices through the diecuts 110, particularly when the tray includes the embossed pattern with the downward projections 24 forming the wells below the food product which captures and contains most of the juices.

The foregoing description and drawings are intended to be illustrative and not restrictive. Various modifications to the embodiments and to the general principles and features of the trays and dies described herein will be apparent to those of skill in the art. Thus, the disclosure should be accorded the widest scope consistent with the appended claims and the full scope of the equivalents to which such claims are entitled.

1. A paper-based bakeable tray, comprising:
a tray formed of paper-based material and capable of withstand oven temperatures between about 150 degrees Fahrenheit and about 500 degrees Fahrenheit, said tray including:
an outer peripheral edge;
a bottom area on which the food product is received, the bottom area including an embossed pattern;
a plurality of diecuts within at least the bottom area.

2. The paper-based bakeable tray of claim 1, further including at least one retaining tab proximate the outer peripheral edge, the retaining tab having a cut edge, the retaining tab being foldable in an upward direction along a fold line such that the cut edge of the retaining tab extends a distance above the bottom area.

3. The paper-based bakeable tray of claim 1, wherein the tray has a shape selected from the group consisting of a circle, a rectangle and a triangle.

4. The paper-based bakeable tray of claim 1, wherein the tray has a shape generally in the shape of the food product received therein.

5. The paper-based bakeable tray of claim 1, wherein the tray further includes a barrier coating such that the tray is generally impermeable to liquid.

6. The paper-based bakeable tray of claim 1, wherein the paper-based material is plant material.

7. The paper-based bakeable tray of claim 6, wherein the plant material is premium grade solid bleached sulfate (SBS) paper.

8. The paper-based bakeable tray of claim 6, wherein the tray has a black color.

9. The paper-based bakeable tray of claim 1, wherein the bottom area further includes raised contour surfaces.

10. The paper-based bakeable tray of claim 1, wherein the embossed pattern includes:
a plurality of upward projections extending upwardly from about 0.01 to about 0.04 inches above a top planar surface of the bottom area such that an uppermost end of said upper projections form an intermittent upper support surface above the top planar surface, whereby the intermittent upper support surface intermittently supports the food product above the top planar surface so as to provide an air space between an underside of the food product and the top planar surface.

11. The paper-based bakeable tray of claim 1, wherein the embossed pattern includes:
a plurality of downward projections extending downwardly below a top planar surface of the bottom area thereby forming a plurality of reservoirs below the top planar surface for collecting liquid which may drip from the food product, the plurality of downward projections extending downward from about 0.01 inches to about 0.04 inches below a bottom surface of the bottom area such that the downward projections form an intermittent lower support surface, the intermittent lower support surface providing an air space allowing for air circulation between the plurality of downward projections.

12. The paper-based bakeable tray of claim 10, wherein the embossed pattern further includes:
a plurality of downward projections extending downwardly below a top planar surface of the bottom area thereby forming a plurality of reservoirs below the top planar surface for collecting liquid which may drip from the food product, the plurality of downward projections extending downward from about 0.01 inches to about 0.04 inches below a bottom surface of the bottom area such that the downward projections form an intermittent lower support surface, the intermittent lower support surface providing an air space allowing for air circulation between the plurality of downward projections.

13. The paper-based bakeable tray of claim 10, wherein the bottom area further includes raised contour surfaces.

14. The paper-based bakeable tray of claim 11, wherein the bottom area further includes raised contour surfaces.

15. The paper-based bakeable tray of claim 12, wherein the bottom area further includes raised contour surfaces.

16. The paper-based bakeable tray of claim 1, wherein each of the diecuts includes a cut edge oriented in one direction.

17. The paper-based bakeable tray of claim 16, further including at least one retaining tab proximate the outer peripheral edge, the retaining tab having a cut edge, the retaining tab being foldable in an upward direction along a fold line such that the cut edge of the retaining tab extends a distance above the bottom area, wherein the cut edge of the retaining tab is oriented toward the cut edge of the diecuts.

18. The paper-based bakeable tray of claim 17, wherein the embossed pattern includes:
a plurality of upward projections extending upwardly from about 0.01 to about 0.04 inches above a top planar surface of the bottom area such that an uppermost end of said upper projections form an intermittent upper support surface above the top planar surface, whereby the intermittent upper support surface supports the food product above the top planar surface so as to provide an air space between an underside of the food product and the top planar surface.

19. The paper-based bakeable tray of claim 17, wherein the embossed pattern includes:
a plurality of downward projections extending downwardly below a top planar surface of the bottom area thereby forming a plurality of reservoirs below the top planar surface for collecting liquid which may drip from the food product, the plurality of downward projections extending downward from about 0.01 inches to about 0.04 inches below a bottom surface of the bottom area such that the downward projections form an intermittent lower support surface, the intermittent lower support surface providing an air space allowing for air circulation between the plurality of downward projections.

20. The paper-based bakeable tray of claim 18, wherein the embossed pattern further includes:
a plurality of downward projections extending downwardly below a top planar surface of the bottom area thereby forming a plurality of reservoirs below the top planar surface for collecting liquid which may drip from the food product, the plurality of downward projections extending downward from about 0.01 inches to about 0.04 inches below a bottom surface of the bottom area such that the downward projections form an intermittent lower support surface, the intermittent lower support surface providing an air space allowing for air circulation between the plurality of downward projections.

21. The paper-based bakeable tray of claim 18, wherein the bottom area further includes raised contour surfaces.

22. The paper-based bakeable tray of claim 19, wherein the bottom area further includes raised contour surfaces.

23. The paper-based bakeable tray of claim 20, wherein the bottom area further includes raised contour surfaces.
